(19) United States
(12) Patent Application Publication
(10) Pub. No.: US 2008/0275710 A1
(43) Pub. Date: Nov. 6, 2008

(54) Scale Searching for Watermark Detection

(75) Inventors: Aweke Negash Lemma, Eindhoven (NL); Leon Maria Van De Kerkhof, Eindhoven (NL); Javier Francisco Aprea, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,788

(22) PCT Filed: Jun. 29, 2005
(86) PCT No.: PCT/IB05/52077

§ 371 Date: Dec. 18, 2006

(30) Foreign Application Priority Data
Jun. 29, 2004 (EP) 04103043.8

(51) Int. Cl. G10L 21/00

(52) U.S. Cl. 704/500; 704/E21.001

(57) ABSTRACT

The present invention relates to a method, device (12) and computer program product for enabling detection of additional data embedded in a media signal that may have been subjected to scaling. The invention also relates to an additional data detecting device (10) comprising such a device for enabling detection. An envelope discriminating unit (ED) provides a first extracted narrow band envelope signal sample (wₑ[n]) from an input media signal sample (y_{b}[n]), and a variable scale down sampling unit (VSDS) down samples the narrow band envelope signal sample using a down sampling rate that is dependent on a scaling factor variable value (η) for providing at least one sample of a first additional data estimate (wₙ[k]) in order to allow the detection of additional data in said signal sample.

### TECHNICAL FIELD

The present invention generally relates to the field of detecting additional data embedded in media signals, such as the detection of watermarks in for instance audio signals and more particularly to a method, device and computer program product for enabling detection of additional data embedded in a media signal as well as to an additional data detecting device comprising such a device for enabling detection.

### DESCRIPTION OF RELATED ART

It is well known to provide additional data in media signals, such as audio signals, where the data can be additional information in relation to the media content as well as a watermark in order to protect the rights of content owners against piracy and fraud.

The signals are here normally provided in digital form as samples of analog signals. In digital audio it is for instance common to sample an analog signal at discrete time intervals and quantize the samples with a given resolution.

When reproducing these signals in a media player, an unintentional error on the nominal sampling frequency may occur as a result of processing, where the reproduced digital signal is at a slightly different and possibly time-varying frequency than the nominal frequency of the signal (e.g. around 1%). Moreover broadcasters may choose to shorten playback time by shrinking the signal through for instance up to 4% pitch-invariant tempo change. The time scaling of the reproduced signal can thus become different.

Because of the situations exemplified above of changed time scaling, it may therefore not be possible to detect a watermark unless something is done.

WO-03/083859 describes one way of solving the problem presented above. In this document a possibly watermarked signal is first framed and then the energy of the framed sample is calculated. During the calculation of the energy an implicit down sampling is performed for providing watermark estimates. After down sampling an interpolation is performed using a scaling factor in order to re-estimate information lost at the energy calculation. After interpolation a watermark estimate is provided which is passed to a correlator, which performs a correlation between the estimate and the actual watermark. A correlation value is therefore passed to a watermark detector, where a possible detection of the watermark is made. In the system a buffer of different estimates is kept and a new interpolation is made until either all scaling factor variations have been used or a watermark has been detected.

In this prior-art, there is thus first thrown away information in the energy computation stage, and then lost information is recreated or estimated in the interpolation stage. This is an inefficient use of the information provided in the input signal.

There is therefore a need for enabling detection of a watermark or other types of data in a signal where the time scaling of the signal is possibly incorrect and that provides a more efficient use of the information provided in the signal.

### SUMMARY OF THE INVENTION

It is therefore an object of the present invention to provide a way to better use the information provided in a media signal, when detecting additional data in said signal if the signal has been subject to possible time scaling.

According to a first aspect of the present invention, this object is achieved by a method of enabling detection of additional data embedded in a media signal comprising the steps of:

obtaining at least one signal sample of a media signal,
detecting the envelope of said signal sample and providing a first extracted narrow band envelope signal sample, and
down sampling the narrow band envelope signal sample using a down sampling rate that is dependent on a scaling factor variable value for providing at least one sample of a first additional data estimate in order to allow the detection of additional data in said signal sample.

According to a second aspect of the present invention, this object is also achieved by a device for enabling detection of additional data embedded in a media signal comprising:

an envelope discriminating unit providing a first extracted narrow band envelope signal sample, and
a variable scale down sampling unit for down sampling the narrow band envelope signal sample using a down sampling rate that is dependent on a scaling factor variable value for providing at least one sample of a first additional data estimate in order to allow the detection of additional data in said signal sample.

According to a third aspect of the present invention, this object is also achieved by an additional data detecting device comprising a device for enabling detection of additional data according to the second aspect, a correlating unit and an additional data detecting unit.

According to a fourth aspect of the present invention, this object is also achieved by a computer program product for enabling detection of additional data embedded in a media signal, comprising computer program code, which, when said program is loaded in the computer, operates to:

obtain at least one signal sample of a media signal,
detect the envelope of said signal sample and provide a first narrow band envelope signal sample, and
down sample the narrow band envelope signal sample using a down sampling rate that is dependent on a scaling factor variable value for providing at least one sample of a first additional data estimate in order to allow the detection of additional data in said signal sample.

The present invention has the advantage of not unnecessarily wasting the information provided in the original signal. Therefore there is no need for an interpolation step to retrieve lost information. It also allows the saving of memory space, in that several different additional data estimates do not have to be stored at the same time. The computations are furthermore relatively simple to make.

The essential idea of the invention is that the envelope of a media signal sample is detected and the resulting narrow band envelope signal is then down sampled using a down sampling rate that is dependent on a variable scaling factor. This allows the detection of additional data embedded in the media signal without having to try to restore lost information.

Claims 3, 9 and 14 are directed towards normalizing extracted narrowband signal samples. This feature has the advantage of simplifying or removing the need for later processing of the first additional data estimate, which lowers the processing power needed.

According to claims 4 and 15, the first additional data estimate is processed, which is necessary for detecting additional data that has been embedded using some embedding schemes and/or which enables the provision of a more robust detection.

According to claims 5 and 7, the processing comprises a step of dividing processed data with a factor based on addition of samples with odd and even indices. This measure provides a second additional data estimate which is a better estimate than the first, especially if there is no normalization, and thus allows a more robust detection of additional data.

According to claim 6, the step of processing comprises subtracting of sample with odd indices from samples with even indices or vice versa, which step is necessary in order to detect additional data that has been embedded using a bi-phase window shaping function.

According to claim 8, the first extracted narrowband envelope signal sample is down sampled. This measure has the advantage allowing a higher performance in terms of less processing time and less memory usage.

According to claims 10 and 11, the detection of the envelope is made by squaring and low pass filtering the input media signal and the low pass filtering is preferably done with a filter whose coefficients match the behavior of the additional data embedded in the signal. This feature has the advantage of providing a better extracted narrow band envelope signal and consequently better additional data estimates.

According to claim 12, the scaling factor variable value is chosen randomly for use in the down sampling of the narrow band envelope signal sample. This has the advantage of speeding up the average processing time.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIGS. 1a and b schematically show raised cosine and bi-phase window shaping functions used for embedding watermarks in media signals,

FIG. 2 schematically shows a watermark detecting device according to a first embodiment of the present invention provided for a watermark that has been embedded using the bi-phase window shaping function,

FIG. 3 schematically shows an envelope discriminating unit used in the watermark detecting device of FIG. 2,

FIG. 4 schematically shows a watermark detecting device according to a second embodiment of the present invention also based on the bi-phase window shaping function,

FIG. 5 schematically shows a watermark detecting device according to a third embodiment of the present invention also based on the bi-phase window shaping function,

FIG. 6 schematically shows a watermark detecting device according to a fourth embodiment of the present invention based on the raised cosine window shaping function,

FIG. 7 schematically shows a watermark detecting device according to a fifth embodiment of the present invention also based on the raised cosine window shaping function, and

FIG. 8 schematically shows a computer program product comprising computer program code for performing the teachings of the present invention.

### DETAILED DESCRIPTION OF EMBODIMENTS

The invention is directed towards the detection of additional data embedded in a media signal. Such additional data is preferably a watermark. However the invention is not limited to watermarks but can be applied for other types of additional data. The media signal will in the following be described in relation to an audio signal. It should however be realized that it is not limited to this type of signal, but can be applied on any type of media signal, like for instance image samples. The description will furthermore be mainly directed towards time domain watermarking, but it should be realized that it is just as well applicable to frequency domain watermarking.

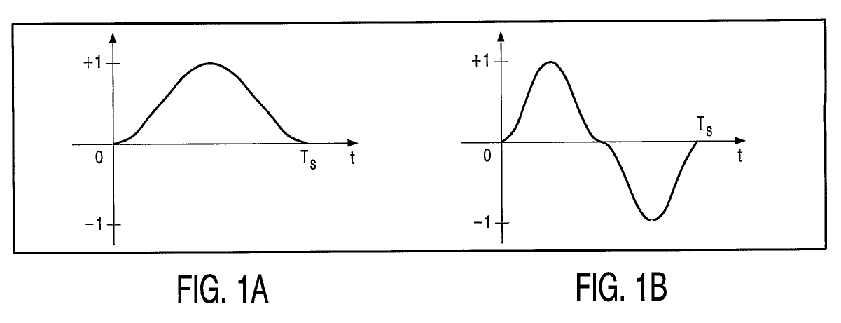

Watermarks are normally embedded in audio signals using window shaping functions, where FIG. 1A shows one such function called raised cosine and FIG. 1B shows another function called bi-phase. Here it can be seen that the bi-phase window shaping function distributes the watermark energy evenly in opposite directions around a DC-level whereas the raised cosine window shaping function places all the watermark energy in only one direction above or below a DC level. This means that watermarks embedded according to these two different functions have to be treated differently. How these functions are used when embedding a watermark in the samples of an audio signal is however well known within the art and a good explanation of how it can be done is made in WO 03/083859, which is herein incorporated by reference.

In the following, various ways of watermark detection will be described. In the description different indices are used for indicating signal samples, which different indices are n, m and k. These are used in order to indicate that a re-sampling has been done and thus that the time scaling of the samples differ between the steps where different indices are used.

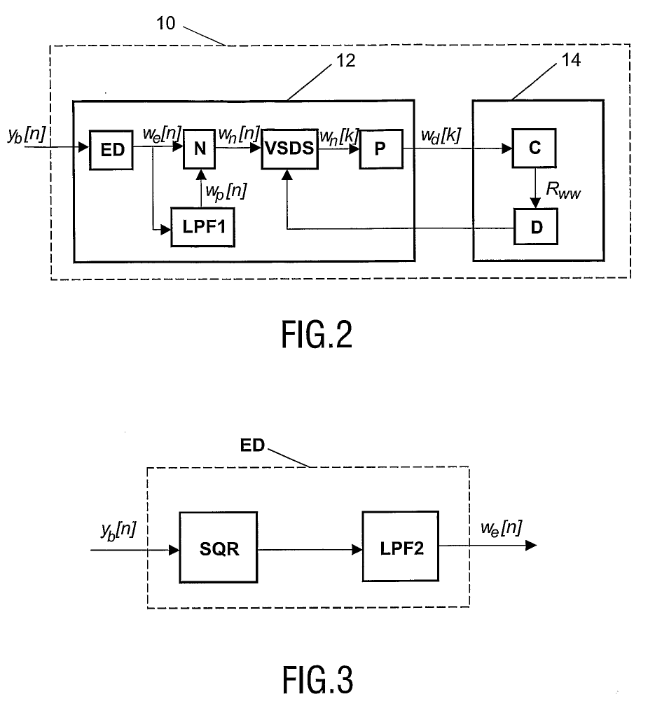

In FIG. 2 there is shown an additional data detecting device in the form of a watermark detecting device 10 according to a first embodiment of the present invention based on the bi-phase window shaping function. The watermark detecting device 10 is shown as a dashed box and comprises a detection stage 14 and an estimate providing stage 12. The estimate providing stage 12 includes an envelope discriminating unit ED connected to a normalizing unit N. The normalizing unit N is connected to a variable scale down sampling unit VSDS, which in turn is connected to a processing unit P, which provides a watermark estimate w_{d}[k] to the detecting stage 14. The estimate providing stage 12 furthermore comprises a first low pass filter LPF1 which is connected to the output of the envelope discriminating unit ED and to the normalizing unit N. The detection stage 14 here includes a correlating unit C and an additional data or watermark detecting unit D connected to each other. The correlating unit C is also connected to the processing unit P of the estimate providing stage 12. The watermark detecting unit D is further connected to the variable scale down sampling unit VSDS of the estimate providing stage 12.

FIG. 3 shows an embodiment of the envelope discriminating unit ED. It comprises a squaring unit SQR connected to a second low pass filter LPF2. The second low pass filter LPF2 can here be a filter whose coefficients match the behavior of the embedded watermark, i.e. it is matched to the window shaping function used, which for the device in FIG. 1 is the bi-phase window shaping function. It should be realized that this is just one way in which to provide an envelope discriminating unit.

The functioning of the device in FIG. 2 will now be described. The envelope discriminating unit ED receives the samples y_{b}[n] of the audio signal and squares and low pass filters these for providing first extracted narrow band envelope signal samples wₑ[n]. The first extracted narrowband envelope signal samples are obtained through computing a sliding average of the input signal samples, where the squaring unit squares the signal and the low pass filtering provides a summation of the squared input samples according to:

$${w}_{e} [ n ] = {\sum }_{i = n + 1}^{n + {T}_{s} / 2} {y}^{2} [ i ] \qquad ( 1 )$$

where Tₛ is the non-scaled watermark symbol period and i is the running index. Note that for window shaping functions other than bi-phase, the limit to the summation above has to be chosen accordingly.

This first extracted narrow band envelope signal is then passed on to the normalizing unit N, which normalizes it with the estimated envelope wₚ[n] of the unwatermarked audio signal. The estimated envelope wₚ[n] is obtained through providing the first narrowband signal wₑ[n] to the first low pass filter LPF1, which low pass filters this signal. The thus normalized first narrowband envelope signal wₙ[n] is then passed to the variable scale down sampling unit VSDS, which down samples the signal wₙ[n] with a varied down sampling rate Tη that is dependent on a scaling factor variable value η. The actual down sampling is performed according to:

Tη=(1+η)Tₛ/2, (2)

where η is said scaling factor variable which is of a few percents allowable variation and varied between ηₘᵢₙ and ηₘₐₓ, and here the scaling factor variable is used starting with ηₘᵢₙ and then incrementing the value up to ηₘₐₓ if it is necessary. The thus downscaled signal wₙ[k], which is a first watermark estimate, is then provided to the processing unit P, which processes it further. Since in this embodiment the watermark detection is provided based on a bi-phase window shaping function, this means that the watermark energy of the two phases should be added together for a correctly scaled signal in order to provide a second watermark estimate w_{d}[k] that enables reliable detection. The processing unit therefore performs a subtracting operation on the first estimate signal according to:

w_{d}[k]=wₑ[2k]−wₑ[2k+1] (3)

This means that samples of odd indices are subtracted from those with even indices. It should furthermore be realized that the subtraction could just as well be performed the other way around, i.e., through subtracting samples of even indices from samples of odd indices.

The thus provided second watermark estimate is then provided to the correlating unit C of the detection stage 14, which correlates the estimate with the reference watermark signal to provide a correlation value R_{ww}. This correlation value R_{ww} is then provided to the detecting unit D, which compares the correlation value R_{ww} with a threshold T. If the correlation value then exceeds said threshold T, a watermark is detected by the detecting unit D. If however the correlation value R_{ww} is below said threshold T, the detecting unit D investigates if the scaling factor η just used was the last, i.e. if it was below ηₘₐₓ in this example, and if it was not it notifies the variable scale down sampling unit VSDS to continue working. The variable scale down sampling unit VSDS then increments the scaling factor η and performs a new down sampling with the new scaling factor, followed by processing and correlation. In this way the watermark detecting device 10 continues until either a watermark is detected or all scaling factors have been used. It should here be realized that the scaling factor variable need not be going from ηₘᵢₙ to ηₘₐₓ, but it is just as well possible to do it the opposite way, i.e. from ηₘₐₓ to ηₘᵢₙ or any other suitable way. It is for instance possible to choose the scaling factor variable randomly and then also to combine this random choice with a grid refinement algorithm, such as the algorithm described in WO-03/083859. By using a randomly chosen scaling factor, the average processing time will be speeded up. Another possible variation is that the choice of scaling factor variable value is based on a previous scaling factor for which a watermark has been detected.

By performing envelope detection and scaling in this way, it is ensured that no vital information is lost when a watermark is detected. By using normalization the processing of the first estimate is furthermore much simplified in the amount of computations performed. This method saves time or computational energy or a combination of both. It also saves memory space, in that several different estimates do not have to be stored. Instead, only one estimate needs to be stored. The computations made are furthermore relatively simple to make.

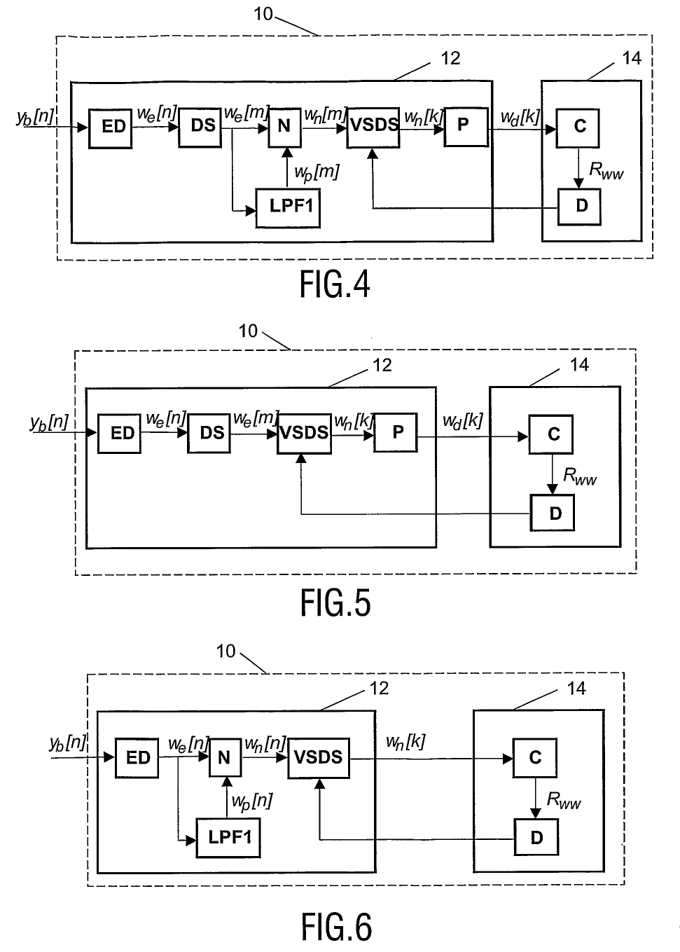

A watermark detector according to a second embodiment is shown in FIG. 4, which differs form the one in FIG. 2 in one detail only. Here there is provided a down sampling unit DS between the envelope discriminating unit ED and the normalizing unit N. This down sampling unit DS down samples the first extracted narrowband envelope signal sample wₑ[n] for providing a second extracted narrowband envelope signal sample wₑ[m]. This second extracted narrowband envelope signal sample wₑ[m] is furthermore used as input for providing the estimate wₚ[m] of the envelope of the unwatermarked audio signal. This down sampling unit DS samples the first extracted narrowband envelope signal at a much slower rate, for instance a rate of 9 times slower than the original sampling frequency, without losing useful information, that is, with the same accuracy. This is valid only when satisfying the Nyquist criterium, i.e. if the maximum frequency of said narrowband envelope does not exceed say 1/18 of the original sampling frequency, which is guaranteed by choosing LPF2 appropriately. This allows for a higher performance in terms of less processing time and less memory usage.

A watermark detecting device according to a third embodiment is shown in FIG. 5. This device differs from the device in FIG. 4 by the removal of the normalization unit and the first low pass filter. The processing unit P also has a different type of processing. Thus here the output of the down sampling unit DS is directly connected to the variable scale down sampling unit VSDS. Since there is no normalization unit provided in this embodiment, the processing unit P has a slightly different way of functioning in order to also provide normalization.

Here the second estimate w_{d}[k] is provided according to:

$${w}_{d} [ k ] = \frac{{w}_{n} [ 2 k ] - {w}_{n} [ 2 k + 1 ]}{{w}_{n} [ 2 k ] + {w}_{n} [ 2 k + 1 ]} \qquad ( 4 )$$

Thus here the estimate w_{d}[k] is provided as a division, where the numerator is an expression of first estimates where samples of odd indices are subtracted from those with even indices or vice versa and the denominator is an expression of first estimates where samples of odd indices are added to those with even indices.

This embodiment has the advantage of providing a more accurate and robust detection. This is due to the fact that the normalization used, i.e. the denominator of expression 4, is here more accurate than the estimate in the first and second embodiments.

There are some variations that can be made to this third embodiment. Firstly it is possible to exclude the down sampling unit DS, in line with what is shown in the first embodiment in FIG. 2 and secondly, if the down sampling unit is included, it is possible to combine it with the variable scale down sampling unit VSDS into one resampling unit together with an intermediate buffer.

What has been described up till now is the detection of watermarks embedded using a bi-phase window shaping function. It is furthermore possible to apply the inventive concept also on detectors provided for watermarks embedded using the raised cosine window shaping function. FIG. 6 shows one such watermark detecting device 10 according to a fourth embodiment of the present invention, which is working in line with the principles of the first embodiment. The difference compared with the first embodiment described in FIG. 2 is that here there is no processing unit P, thus here the variable scale down sampling unit VSDS is directly connected to the correlating unit C. In all other respects the device is the same as the device in FIG. 2. The processing unit is not needed here because all the watermark energy is provided with the same polarity and thus there is no need to re-process it.

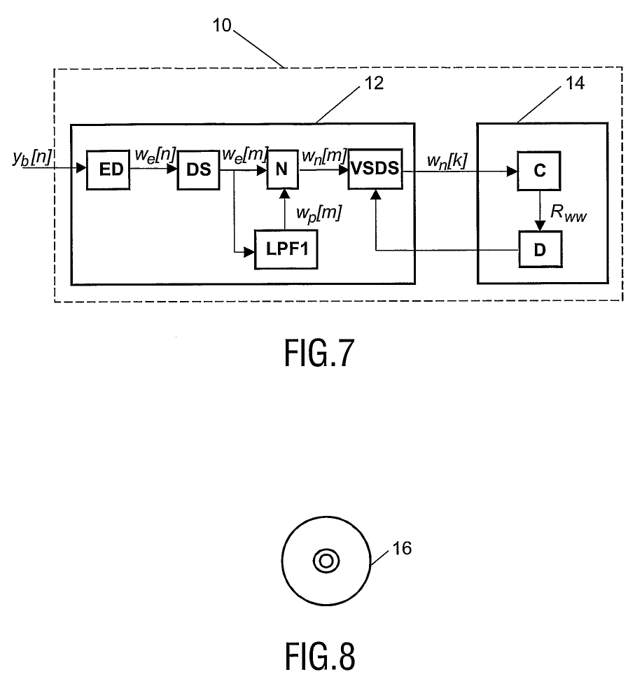

FIG. 7 shows a fifth embodiment of a watermark detecting device used for raised cosine window shaped watermarked signals, which is working in line with the principles of the device of the second embodiment. The only difference from the second embodiment is also here that there is no processing unit needed.

It should furthermore be realized that a watermark detection device used for raised cosine window shaped watermarked signals can also be provided in line with the principles of the third embodiment. A device according to a sixth embodiment would then look as the device in FIG. 5, but where the processing unit P would work a bit differently than the device in the third embodiment.

In this sixth embodiment the second estimate would be provided according to:

$${w}_{d} [ k ] = \frac{{w}_{n} [ k ]}{\frac{1}{L} * {\sum }_{i = k - L / 2}^{k + L / 2} {w}_{n} [ i ]} \qquad ( 5 )$$

where L is an integer larger than say 6.

In all other aspects it would in essence function in the same way as the device according to the third embodiment. The device according to this sixth embodiment could furthermore be the subject of the same variations as the device according to the third embodiment.

As was mentioned previously the invention is also applicable to watermarks embedded in the frequency domain. The same structure as outlined in all the embodiments mentioned above could in this case be used. The detection device would however then need to frame the input signal, transform the framed signal into the frequency domain, take the absolutes of the corresponding FFT values on a number of frames and average them in order to provide a frequency domain signal sample which would then be provided to the envelope discriminating unit. From there on the processing according to any of the above-described embodiments is performed.

The present invention has been described in relation to a device for enabling detection of a watermark and a watermark detecting device including such a device. One or both of the devices is preferably provided in the form of one of more processors containing program code for performing the processing according to the present invention. This program code can also be provided on a computer program medium, like a CD ROM 16, which is generally shown in FIG. 8. The previously described operations in the units of the devices according to the invention are then performed when the program from said CD ROM is loaded in a computer. The program code can furthermore be downloaded from a server, for example via the Internet.

It should be emphasized that the term “comprises/comprising” when used in this specification is taken to specify the presence of stated features, variable values, constants, steps or components, but does not preclude the presence or addition of one or more other features, variable values, constants, steps, components or groups thereof. It should furthermore be realized that reference signs appearing in the claims should in no way be construed as limiting the scope of the present invention.

1. Method of enabling detection of additional data embedded in a media signal (y) comprising the steps of:
obtaining at least one signal sample (y_{b}[n]) of a media signal,
detecting the envelope of said signal sample and providing a first extracted narrow band envelope signal sample (wₑ[n]), and
down sampling the narrow band envelope signal sample using a down sampling rate that is dependent on a scaling factor variable value (η) for providing at least one sample of a first additional data estimate (wₙ[k]) in order to allow the detection of additional data in said signal sample.

2. Method according to claim 1, further comprising the step of detecting whether additional data is present or not in the estimate and repeating the step of down sampling using another scaling factor variable value in case said additional data has not been detected.

3. Method according to claim 1, further comprising the step of normalizing said first extracted narrow band envelope signal (wₑ[n]) with an estimate (wₚ[n]) of the envelope of said media signal.

4. Method according to claim 1, further comprising the step of processing said first additional data estimate (wₙ[k]) for providing a second additional data estimate (w_{d}[k]), which is used for detection of additional data.

5. Method according to claim 4, wherein the processing comprises a step of dividing said first additional data estimate with a factor based on addition of samples with odd and even indices (wₙ[2k]+wₙ[2k+1]).

6. Method according to claim 4, wherein at least two samples of said first additional data estimate are obtained and the processing comprises subtraction of samples with odd indices from those with even indices (wₙ[2k]−wₙ[2k+1]) or vice-versa.

7. Method according to claim 6, wherein the processing further comprises a step of dividing said first additional data estimate with a factor based on addition of samples with odd and even indices (wₙ[2k]+wₙ[2k+1]).

8. Method according to claim 1, further comprising the step of down sampling said first extracted narrowband envelope signal sample (wₑ[n]) for providing a second extracted narrowband envelope signal sample (wₑ[m]) to be used for the later processing steps.

9. Method according to claim 8, further comprising the step of normalizing said second extracted narrow band envelope signal (wₑ[m]) with an estimate (wₚ[m]) of the envelope of said media signal.

10. Method according to claim 1, wherein the step of detecting the envelope comprises squaring and low pass filtering the obtained signal sample.

11. Method according to claim 10, wherein said low pass filtering is performed with a filter whose coefficients match the behavior of the additional data embedded in said media signal.

12. Method according to claim 1, further comprising the step of selecting a random scaling factor variable value and using the selected value in said down sampling of the narrow band envelope signal sample.

13. Device (12) for enabling detection of additional data embedded in a media signal (y) comprising:
an envelope discriminating unit (ED) providing a first extracted narrow band envelope signal sample (wₑ[n]), and
a variable scale down sampling unit (VSDS) for down sampling the narrow band envelope signal sample using a down sampling rate that is dependent on a scaling factor variable value (η) for providing at least one sample of a first additional data estimate (wₙ[k]) in order to allow the detection of additional data in said signal sample.

14. Device according to claim 13, further comprising a normalizing unit (N) arranged to normalize an extracted narrow band envelope signal (wₑ[n]; wₑ[m]) with an estimate (wₚ[n]; wₚ[m]) of the envelope of said media signal.

15. Device according to claim 13, further comprising a processing unit (P) arranged to process the first additional data estimate for providing a second additional data estimate (w_{d}[k]), which is used for detection of additional data.

16. Additional data detecting device (10) comprising a device (12) for enabling detection of additional data according to claim 13, a correlating unit (C) and an additional data detecting unit (D).

17. Computer program product (16) for enabling detection of additional data embedded in a media signal (y), comprising computer program code, which, when said program is loaded in the computer, operates to:
obtain at least one signal sample (y_{b}[n]) of a media signal,
detect the envelope of said signal sample and providing a first narrow band envelope signal sample (wₑ[n]), and
down sample the narrow band envelope signal sample using a down sampling rate that is dependent on a scaling factor variable value (η) for providing at least one sample of a first additional data estimate (wₙ[k]) in order to allow the detection of additional data in said signal sample.
